(19) United States
(12) Patent Application Publication
(10) Pub. No.: US 2017/0025706 A1
(43) Pub. Date: Jan. 26, 2017

(54) ELECTROLYTE ADDITIVES FOR LITHIUM ION BATTERIES

(71) Applicant: 3M INNOVATIVE PROPERTIES COMPANY, St. Paul, MN (US)

(72) Inventors: Jeffrey R. Dahn, Nova Scotia (CA); Jian Xia, Nova Scotia (CA); Yaohui Wang, Fujian (CN); Remi Petibon, Nova Scotia (CA); Lin Ma, Nova Scotia (CA); Kathlyne Nelson, Ontario (CA); Laura E. Downie, Minneapolis, MN (US)

(21) Appl. No.: 15/300,872

(22) PCT Filed: Apr. 1, 2015
(86) PCT No.: PCT/US2015/023800

§ 371 Date: Sep. 30, 2016

Related U.S. Application Data
(60) Provisional application No. 61/974,993, filed on Apr. 3, 2014.

(51) Int. Cl. H01M 10/0567; H01M 10/0525

(52) U.S. Cl. CPC H01M 10/0567; H01M 10/0525; H01M 2300/0025

(57) ABSTRACT

Improved nonaqueous electrolytes have been developed for lithium ion batteries. The electrolytes comprises a lithium salt, a nonaqueous carbonate solvent, and an additive mixture comprising at least one group A compound, at least one group B compound, and at least one group C compound wherein the group A compound is selected from the group consisting of VC and PES, the group B compound is selected from the group consisting of MMDS, DTD, TMS, ES, and PS, and the group C compound is selected from the group consisting of TTSP and TTSPi. Certain ternary or quaternary additive mixtures can: reduce parasitic reactions at the positive electrode above 4.1 V compared to use of VC alone; increase the thermal stability of a charged graphite electrode at elevated temperature; improve coulombic efficiency; and also reduce impedance of the batteries. These factors all suggest longer lived, safer, higher power lithium batteries with better tolerance to high voltages which will improve energy density.

### TECHNICAL FIELD

The present invention pertains to electrolytes for lithium ion batteries and additives for such electrolytes. In particular, it pertains to ternary and quaternary electrolyte additives for such batteries.

### BACKGROUND

Electrolyte additives are used in Li-ion cells to improve lifetime and performance [e.g. S. S. Zhang, Journal of Power Sources 162, 1379, (2006); and K. Xu, Chemical Reviews 104, 4303, (2004)]. Most commonly researchers study the impact of a single additive on the properties of Li-ion cells for either the positive or negative electrode alone [M. Broussely, Advances in Lithium-Ion Batteries, Kluwer Academic/Plenum Publishers, New York, 2002, pp 393-432; S. Patoux, L. Daniel, C. Bourbon, H. Lignier, C. Pagano, F. L. Cras, S. Jouanneau and S. Martinet, J. Power Sources, 189, 344 (2009); and X. X. Zuo, C. J. Fan, X. Xiao, J. S. Liu and J. M. Nan, J. Power Sources, 219, 94 (2012)]. However, it is common knowledge that commercial Li-ion cells often incorporate several electrolyte additives that, apparently, work synergistically together. Recently, in J. C. Burns et al., J. Electrochem. Soc., 160, A1451 (2013), this synergy was demonstrated in studies of Li-ion cells containing up to five proprietary, undisclosed electrolyte additives where cycle life was increased 20 times compared to electrolyte with no additives and over 5 times compared to cells with only one additive. Simultaneously, impedance could be reduced by an appropriate selection of proprietary, undisclosed additives.

Advances to electrolyte additive technologies continue to be made that provide substantial useful improvements to various lithium ion battery characteristics. This invention provides similar such improvements and other advantages as revealed in the following.

### SUMMARY

Certain nonaqueous electrolytes containing an additive mixture comprising 1) VC or PES and 2) a sulphur containing additive compound, and 3) TTSP or TTSPi have been found to impart the simultaneous advantages of high coulombic efficiency, excellent storage properties and low impedance after cycling or storage when used in lithium ion batteries. PES-containing electrolytes generate less gas during storage at 60° C. than VC-containing electrolytes. Further, use of such electrolytes has also been shown to improve cycling life. Further still, experimental results also suggest that the electrolytes with additive mixtures can improve charge discharge cycling of NMC-based cells to 4.4 V and above.

Specifically, the nonaqueous electrolyte for a lithium ion battery comprises a lithium salt (e.g. LiPF₆), a nonaqueous carbonate solvent (e.g. EC and/or EMC), and an additive mixture comprising at least one group A compound, at least one group B compound, and at least one group C compound wherein the group A compound is selected from the group consisting of VC and PES, the group B compound is selected from the group consisting of MMDS, DTD, TMS, ES, and PS, and the group C compound is selected from the group consisting of TTSP and TTSPi.

The concentration of the at least one group A compound can be in the range from 0.5 to 3% by weight. The concentration of the at least one group B compound can be in the range from 0.25 to 3% by weight. The concentration of the at least one group C compound can be in the range from 0.25 to 3% by weight.

### BRIEF DESCRIPTION OF THE DRAWINGS

FIGS. 1a-1d show typical data collected during some of the experiments. FIG. 1a shows coulombic efficiency (CE) versus cycle number. FIG. 1b shows the capacity of the charge endpoint plotted versus cycle number. FIG. 1c shows open circuit voltage versus time during storage at 4.2 V and

FIG. 1d shows AC impedance spectra for cells measured after the 15 cycles of UHPC testing. Data for electrolytes with 2% VC and 2% VC+1% TMS+0.5% TTSPi+0.5% TTSP are shown.

FIGS. 2a and 2b show the Figure of Merit for the electrolyte additives considered in Table 1.

FIG. 3 shows the Figure of Merit for the electrolyte additives considered in Table 2.

FIG. 4 shows R_{ct} measured after UHPC cycling versus CIE/h for all additives in Table 1 where data is available. Inventive compositions 1-10 are defined in Table 1 and the symbols “1” to “10” are placed on the graph where the data point lies. Other inventive compositions are designated with data points marked “y”.

FIG. 5 shows R_{ct} after storage versus the voltage drop during storage. Inventive compositions 1-10 (where data is available) are defined in Table 1 and the symbols “1” to “10” are placed on the graph where the data point lies. Other inventive compositions are designated with data points marked “y”.

FIG. 6 shows gas evolved after UHPC cycling plotted versus coulombic inefficiency. Inventive compositions 1-10 are defined in Table 1 and the symbols “1” to “10” are placed on the graph where the data point lies. Other inventive compositions are designated with data points marked “y”.

FIG. 7 shows R_{ct} after UHPC cycling versus CIE/h for the electrolytes in Table 2. The data point symbols are defined in Table 2.

FIG. 8 shows R_{ct} after 60° C. storage plotted versus the voltage drop during storage at 60° C. for cells containing the electrolytes of Table 2. The data point symbols are defined in Table 2.

FIGS. 9a and 9b show capacity versus cycle number for cells charged and discharged at 55° C. FIG. 9a shows results for 2% VC, 2% VC+1% MMDS and the inventive composition 2% VC+1% MMDS+1% TTSPi. FIG. 9b shows results for 2% VC, 2% VC+1% DTD and the inventive composition 2% VC+1% DTD+1% TTSPi.

FIGS. 10a and 10b show capacity versus cycle number for cells charged and discharged at 55° C. FIG. 10a shows results for 2% PES, 2% PES+1% MMDS, 2% PES+1% TTSPi and the inventive composition 2% PES+1% MMDS+1% TTSPi. FIG. 10b shows results for 2% PES, 2% PES+1% DTD, 2% PES+1% TTSPi and the inventive composition 2% PES+1% DTD+1% TTSPi.

FIGS. 11a-11d show the AC impedance spectra of NMC442/graphite cells cycled between the indicated potential limits for 400 to 500 hours at 40° C. Cells with electrolytes containing 2% VC, 2% PES and the inventive composition 2% VC+1% MMDS+1% TTSPi are featured.

FIG. 12a shows isothermal microcalorimetry results (using the methods of reference [6]) for NMC111/graphite pouch cells, and FIG. 12b shows the difference between the heat flow from control A and the various other electrolytes.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and not limited to just one. Further, in a numerical context, the word “about” is to be construed as meaning plus or minus 10%.

### ABBREVIATIONS

The abbreviations for the electrolyte solvents and salts used in the reported studies are defined below:

### Salt

LiPF₆—lithium hexafluorophosphate

### Solvents Used

EC—ethylene carbonate

EMC—ethyl methyl carbonate

### Electrolyte Additives Used in Inventive Compositions

Group A:

VC—vinylene carbonate

PES—prop-1-ene-1,3-sultone

Group B:

DTD-1,3,2-Dioxathiolane-2,2-dioxide—also called ethylene sulfate

TMS—1,3,2-Dioxathiane 2,2-dioxide—also called trimethylene sulfate,

MMDS—1,5,2,4-dioxadithiane-2,2,4,4-tetraoxide—also called methylene methane disulfonate,

PS—1,3-Propane sultone

ES—Ethylene Sulfite

Group C:

TTSP—tris(-trimethly-silyl)-phosphate

TTSPi—tris(-trimethyl-silyl)-phosphite

### Other Additives Used

PMS—propargyl methane sulfonate

AMS—allyl methanesulfonate BSF—Butadiene sulfone

PLS—propylene sulfate

SA—Succinic Anhydride

MA—Maleic anhydride

OHD—3-Oxabicyclo[3.1.0]hexane-2,4-dione

BMI—1,1′-(methylenedi-4,1-phenylene)bismaleimide

### REFERENCES

In the description below, reference is made to the following publications as indicated by the number in square brackets.
[1] T. M. Bond, J. C. Burns, D. A. Stevens, H. M. Dahn, and J. R. Dahn, J. Electrochem. Soc., 160, A521 (2013).
[2] N. N. Sinha, T. H. Marks, H. M. Dahn, A. J. Smith, D. J. Coyle, J. J. Dahn and J. R. Dahn, J. Electrochem. Soc., 159, A1672 (2012).
[3] L. J. Krause, L. D. Jensen, and J. R. Dahn, J. Electrochem. Soc., 159, A937-A943 (2012).
[4] J. C. Burns, Adil Kassam, N. N. Sinha, L. E. Downie, Lucie Solnickova, B. M. Way and J. R. Dahn, Predicting and Extending the Lifetime of Li-ion Batteries, J. Electrochem. Soc. 160, A1451-A1456 (2013).
[5] David Yaohui Wang, N. N. Sinha, R. Petibon, J. C. Burns and J. R. Dahn, A systematic study of well-known electrolyte additives in LiCo02/graphite pouch cells, Journal of Power Sources, 251, 311-318 (2014).
[6] Laura E. Downie, Kathlyne J. Nelson, Remi Petibon, V. L. Chevrier and J. R. Dahn, The impact of electrolyte additives determined using isothermal microcalorimetry, ECS Electrochemical Letters 2, A106-A109 (2013).

Electrolytes of the invention can be prepared by first obtaining a stock mixture of an appropriate nonaqueous carbonate solvent or solvents (e.g. EC:EMC as used in the following Examples). To this stock mixture, an amount of an appropriate lithium salt (e.g. LiPF6 salt again as used in the following Examples). Finally, the inventive electrolyte is prepared with a desired additive or additives in an appropriate weight %. As those skilled in the art will appreciate, the type of additive to be used and the amount to be employed will depend on the characteristics which are most desirably improved and the other components and design used in the lithium ion batteries to be made. Guidance in making these selections can be gleaned from the detailed Examples below.

Lithium ion batteries can then be prepared in a variety of conventional manners using the appropriately prepared electrolyte with additive mixture.

The following examples are provided to illustrate certain aspects of the invention but should not be construed as limiting in any way.

### Examples

In the following, machine made “pouch cells” were used to evaluate lithium ion battery characteristics using a variety of electrolyte compositions.

### Pouch Cells

1 M LiPF6 EC/EMC (3:7 wt. % ratio, from BASF) was used as the control electrolyte in the studies reported here. To this electrolyte, various electrolyte additives, listed in Tables 1 and 2 (below), were added either singly or in combination. Additive components were added at specified weight percentages in the electrolyte.

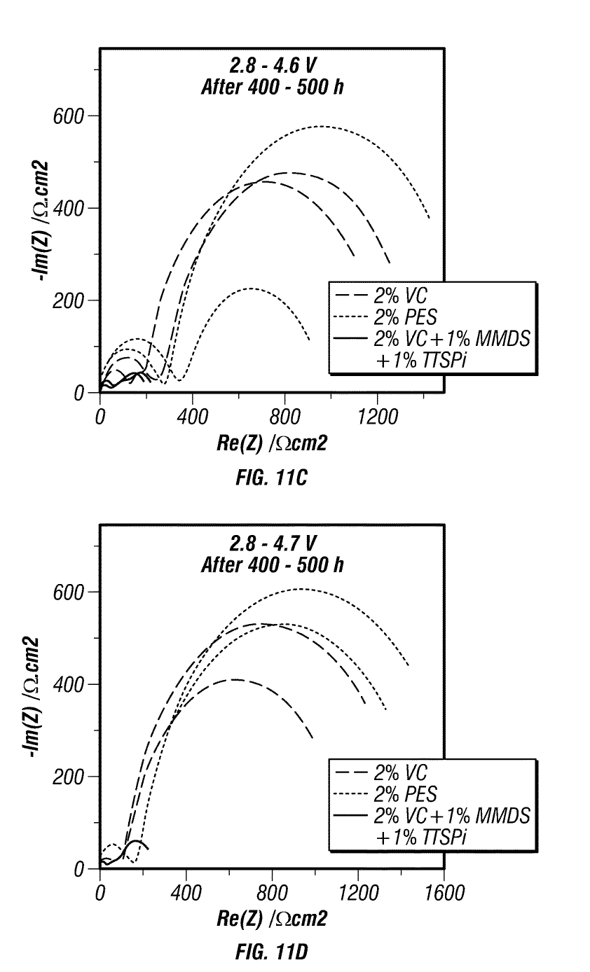

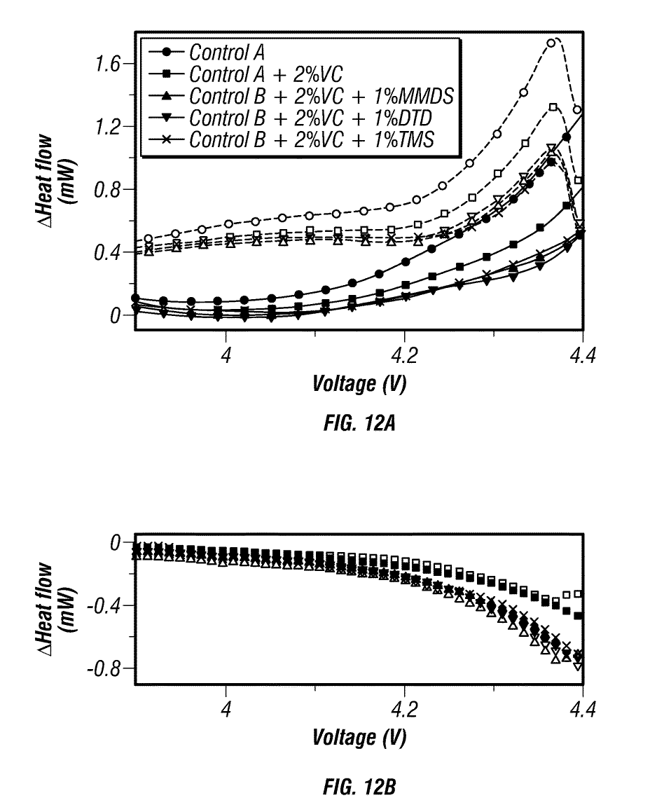

Dry Li[Ni_{1/3}Mn_{1/3}Co_{1/3}]O₂ (NMC111)/graphite pouch cells (220 mAh) balanced for 4.2V operation (described in the results of Table 1) and dry Li[Ni_{1/3}Mn_{1/3}Co_{1/3}]O₂ (NMC111)/graphite pouch cells (240 mAh) balanced for 4.4 V operation (described in the results of Table 2) were obtained from Whenergy (Shandong, China). Both cells types were normally tested only to an upper cutoff potential of 4.2 V (for example all results in Tables 1 and 2 are for 4.2 V operation) except in special cases (FIG. 12) where the “4.4 V cells” were tested to 4.4 V. Dry Li[Ni_{0.42}Mn_{0.42}Co_{0.16}]O₂ (NMC442)/graphite pouch cells (240 mAh) balanced for 4.7 V operation were also obtained from Whenergy and used in some special experiments (FIG. 11).

All pouch cells were vacuum sealed without electrolyte in China and then shipped to our laboratory in Canada. Before electrolyte filling, the cells were cut just below the heat seal and dried at 80° C. under vacuum for 12 h to remove any residual water. Then the cells were transferred immediately to an argon-filled glove box for filling and vacuum sealing. The NMC/graphite pouch cells were filled with 0.9 g of electrolyte. After filling, cells were vacuum-sealed with a compact vacuum sealer (MSK-115A, MTI Corp.). First, cells were placed in a temperature box at 40.0±0.1° C. where they were held at 1.5 V for 24 hours, to allow for the completion of wetting. Then, cells were charged at 11 mA (C/20) to 4.2 V and discharged to 3.8 V. After this step, cells were transferred and moved into the glove box, cut open to release gas generated and then vacuum sealed again.

### Electrochemical Impedance Spectroscopy

Electrochemical impedance spectroscopy (EIS) measurements were conducted on NMC/Graphite pouch cells after storage and also after cycling on the UHPC. Cells were charged or discharged to 3.80 V before they were moved to a 10.0±0.1° C. temperature box. AC impedance spectra were collected with ten points per decade from 100 kHz to 10 mHz with a signal amplitude of 10 mV at 10.0±0.1° C. A Biologic VMP-3 was used to collect this data.

### Ultrahigh Precision Cycling and Storage Experiments

The cells were cycled using the Ultra High Precision Charger (UHPC) at Dalhousie University [1] between 2.8 and 4.2 V at 40.0±0.1° C. using currents corresponding to C/20 for 15 cycles where comparisons were made. The cycling/storage procedure used in these tests is described as follows. Cells were first charged to 4.2 V and discharged to 2.8 V two times. Then the cells were charged to 4.2 V at a current of C/20 (11 mA) and then held at 4.2 V until the measured current decreased to C/1000. A Maccor series 4000 cycler was used for the preparation of the cells prior to storage. After the pre-cycling process, cells were carefully moved to the storage system which monitored their open circuit voltage every 6 hours for a total storage time of 500 h [2]. Storage experiments described in Table 1 were made at 40±0.1° C. Storage experiments described in Table 2 were made at 60±0.1° C.

### Determination of Gas Evolution in Pouch Cells

Ex-situ (static) gas measurements were used to measure gas evolution during formation and during cycling. The measurements were made using Archimedes' principle with cells suspended from a balance while submerged in liquid. The changes in the weight of the cell suspended in fluid, before and after testing are directly related to the volume changes by the change in the buoyant force. The change in mass of a cell, Am, suspended in a fluid of density, ρ, is related to the change in cell volume, Δv, by

Δv=Δm/ρ equation 1

Ex-situ measurements were made by suspending pouch cells from a fine wire “hook” attached under a Shimadzu balance (AUW200D). The pouch cells were immersed in a beaker of de-ionized “nanopure” water (18.2 MΩ·cm) that was at 20±1° C. for measurement.
Isothermal Battery calorimetry

Cycling of cells inside the microcalorimeter was performed using a Maccor series 4000 automated test system (Maccor Inc.). Isothermal heat flow microcalorimetry measurements were performed using a TAM III calorimeter (TA Instruments), with a measurement uncertainty of <±1.0 μW and at a temperature of 40.0±0.1° C. The specifics of the instrument calibration and operation, background information, and methods are discussed in detail in Reference [3]. The noise level of the instrument is about 10 nW and the baseline drift from 0.00 μW was less than 500 nW over the time frame of the experiments conducted here.

TABLE 1
List of properties of NMC111/graphite cells with electrolyte additives listed in
first column

| | | | | Charge | Rct | Voltage | Rct | | Gas |
|---|---|---|---|---|---|---|---|---|---|
| | | | | slippage | After | drop | after | | after |
| | | | | (mAh | UHPC | 40 C. | storage | form. | UHPC |
| | | | CIE/h × | per | Ohm * | stor. | Ohm * | gas | cyc. |
| Additives | FOM | Inv | 10⁻⁵ | cycle) | cm² | (V) | cm² | (mL) | (mL) |
| Control | 57.3 | | 15.0 | 1.05 | 63 | | | | |
| 2% VC - old formation | 22.93 | VC | 4.6 | 0.24 | 89 | | | 0.15 | −0.0276 |
| 2% VC new formation | 22.67 | VC | 4.0 | 0.25 | 96 | 0.088 | 101 | 0.08 | 0.0629 |
| 3% VC | 27.24 | n | 4.7 | 0.21 | 136 | 0.061 | 209 | 0.11 | −0.0108 |
| 1% PMS | 151.10 | n | 45.1 | 2.79 | 51 | 0.168 | 41 | 0.57 | 0.0304 |
| 2% PMS | 140.53 | n | 37.6 | 3.00 | 53 | 0.156 | 40 | 0.72 | 0.0225 |
| 2% VC + 1% PMS | 26.75 | n | 5.5 | 0.26 | 106 | 0.055 | 113 | 0.08 | 0.0235 |
| 2% VC + 2% PMS | 31.71 | n | 5.8 | 0.25 | 152 | 0.065 | 162 | 0.10 | 0.0361 |
| 1% AMS | 130.87 | n | 39.4 | 2.37 | 45 | 0.168 | 39 | 1.13 | 0.0325 |
| 2% AMS | 115.30 | n | 34.4 | 2.07 | 50 | 0.180 | 43 | 1.20 | 0.0149 |
| 2% VC + 1% AMS | 22.23 | n | 5.1 | 0.27 | 68 | 0.090 | 79 | 0.18 | 0.0249 |
| 2% VC + 2% AMS | 27.46 | n | 6.3 | 0.31 | 86 | 0.093 | 85 | 0.18 | 0.0227 |
| 1% BSf | 129.31 | n | 34.0 | 2.80 | 52 | | | 0.60 | −0.0369 |
| 2% BSf | 144.41 | n | 38.0 | 3.12 | 60 | | | 0.63 | −0.0154 |
| 2% VC + 1% BSf | 28.91 | n | 6.1 | 0.44 | 79 | | | 0.13 | −0.0339 |
| 2% VC + 2% BSf | 28.66 | n | 6.0 | 0.43 | 80 | | | 0.12 | −0.0257 |
| 1% LiBOB + 1% VC | | n | 4.9 | 0.36 | | | | 0.12 | 0.0011 |
| 1% LiBOB + 2% VC | | n | 4.8 | 0.30 | | 0.091 | | 0.07 | 0.0148 |
| 1% LiBOB + 1% MMDS | | n | 4.5 | 0.35 | | 0.079 | | 0.26 | −0.0154 |
| 2% PS | 31.73 | n | 8.9 | 0.49 | 40 | | | 0.41 | 0.0062 |
| 4% PS | 31.16 | n | 8.2 | 0.43 | 62 | | | 0.28 | −0.0208 |
| 2% VC + 2% PS | 34.88 | n | 4.4 | 0.19 | 223 | | | 0.08 | −0.0025 |
| 2% VC + 4% PS | 47.72 | n | 4.3 | 0.19 | 354 | | | 0.09 | −0.0115 |
| 1% DTD | 20.96 | n | 5.7 | 0.29 | 37 | 0.094 | 43 | 0.83 | −0.0657 |
| 2% DTD | 19.72 | B | 4.7 | 0.27 | 50 | 0.093 | 42 | 1.01 | −0.065 |
| 2% VC + 1% DTD | 23.63 | n | 3.4 | 0.19 | 129 | 0.088 | 99 | 0.36 | −0.0362 |
| 2% VC + 2% DTD | 24.15 | n | 4.3 | 0.24 | 109 | 0.087 | 117 | 0.42 | −0.0161 |
| 1% TMS | 74.38 | n | 21.7 | 1.30 | 49 | 0.133 | 42 | 0.57 | −0.0297 |
| 2% TMS | 28.57 | n | 7.6 | 0.44 | 47 | 0.124 | 40 | 0.44 | −0.0371 |
| 2% VC + 1% TMS | 23.75 | n | 4.1 | 0.20 | 114 | 0.085 | 110 | 0.05 | −0.0318 |
| 2% VC + 2% TMS | 21.27 | n | 4.0 | 0.20 | 93 | 0.083 | 106 | 0.05 | −0.0414 |
| | 0.00 | | | | | | | | |
| 1% PLS | 26.21 | n | 6.4 | 0.35 | 64 | 0.103 | 57 | 0.58 | −0.0312 |
| 2% PLS | 26.32 | n | 6.6 | 0.34 | 64 | 0.109 | 52 | 0.54 | −0.0951 |
| 2% VC + 1% PLS | 26.44 | n | 5.1 | 0.27 | 110 | 0.105 | 152 | 0.16 | −0.0648 |
| 2% VC + 2% PLS | 28.74 | n | 5.1 | 0.31 | 122 | 0.114 | 138 | 0.15 | −0.0537 |
| | 0.00 | | | | | | | | |
| 1% MMDS | 0.00 | n | | | | 0.121 | 66 | 0.32 | |
| 2% VC + 1% MMDS | 19.51 | A | 4.0 | 0.19 | 76 | 0.072 | 84 | 0.13 | −0.0265 |
| 2% VC + 2% PS + 1% MMDS | 28.11 | n | 3.0 | 0.21 | 178 | 0.057 | 268 | 0.11 | |
| 2% VC + 4% PS + 1% MMDS | 35.81 | C | 2.9 | 0.20 | 260 | 0.057 | 363 | 0.09 | |
| 1% ES | 116.24 | n | 29.8 | 2.52 | 63 | 0.321 | 51 | 2.34 | |
| 2% ES | 253.86 | n | 72.2 | 4.92 | 111 | 0.428 | 62 | 3.10 | |
| 2% VC + 1% ES | 21.65 | n | 5.1 | 0.28 | 57 | 0.101 | 53 | 0.10 | |
| 2% VC + 2% ES | 22.17 | n | 5.6 | 0.30 | 50 | 0.117 | 51 | 0.10 | |
| 5% MMDS | 38.11 | n | 3.6 | 0.29 | 251 | 0.089 | 129 | 0.48 | |
| 2% VC + 5% MMDS | 44.48 | n | 3.6 | 0.24 | 324 | 0.093 | 254 | 0.36 | |
| 2% VC + 1% DTD + 1% TTSPi | 23.71 | y | 3.8 | 0.21 | 119 | 0.073 | 72 | 0.38 | −0.0189 |
| 2% VC + 2% DTD + 2% TTSPi | 29.06 | y | 4.1 | 0.23 | 163 | 0.091 | 123 | 0.58 | −0.02 |
| 2% VC + 1% TMS + 1% TTSPi | 20.76 | y | 4.0 | 0.20 | 87 | 0.054 | 70 | 0.15 | 0.0105 |
| 2% VC + 2% TMS + 2% TTSPi | 21.91 | y | 4.1 | 0.20 | 98 | 0.050 | 106 | 0.11 | 0.0727 |
| 1% TTSP | 30.98 | n | 8.5 | 0.45 | 48 | | | | |
| 2% TTSP | 29.22 | n | 8.1 | 0.42 | 45 | | | | |
| 3% TTSP | 27.20 | n | 7.5 | 0.38 | 45 | | | | |
| 1% TTSPi | 35.40 | n | 11.4 | 0.41 | 44 | | | | |
| 2% TTSPi | 22.28 | n | 6.2 | 0.31 | 37 | | | | |
| 3% TTSPi | 21.95 | n | 6.3 | 0.30 | 32 | | | | |
| 2% VC + 1% TTSP | 25.48 | n | 6.2 | 0.36 | 57 | | | | |
| 2% VC + 2% TTSP | 23.24 | n | 5.8 | 0.31 | 55 | | | | |
| 2% VC + 3% TTSP | 25.22 | n | 5.9 | 0.33 | 67 | | | | |
| 2% VC + 1% TTSPi | 22.88 | n | 5.9 | 0.29 | 52 | | | | |
| 2% VC + 2% TTSPi | 23.45 | n | 5.7 | 0.29 | 63 | | | | |
| 2% VC + 3% TTSPi | 23.61 | n | 5.5 | 0.27 | 73 | | | | |
| 1% 21993 | | n | 9.6 | 0.66 | | | | 0.18 | |
| 2% 21993 | | n | 8.9 | 0.56 | | | | 0.16 | |
| 2% VC + 1% 21993 | | n | 4.8 | 0.33 | | | | 0.09 | |
| 2% VC + 2% 21993 | | n | 5.7 | 0.32 | | | | 0.08 | |
| 1% 21894 | | n | 15.1 | 1.19 | | | | 0.18 | |
| 2% 21894 | | n | 13.1 | 0.94 | | | | 0.28 | |
| 2% VC + 1% 21894 | | n | 5.0 | 0.28 | | | | 0.10 | |
| 2% VC + 2% 21894 | | n | 5.4 | 0.31 | | | | 0.09 | |
| 0.2% SA | 61.64 | n | 15.6 | 1.22 | 61 | | | 0.20 | −0.0327 |
| 1% SA | 47.33 | n | 7.5 | 0.58 | 206 | | | 0.06 | −0.0336 |
| 2% VC + 0.2% SA | 31.50 | n | 3.8 | 0.26 | 188 | | | 0.08 | −0.06 |
| 2% VC + 1% SA | 138.99 | n | 3.8 | 0.26 | 1262 | | | 0.06 | −0.044 |
| 0.2% MA | 45.50 | n | 10.7 | 0.82 | 76 | | | 0.27 | −0.0783 |
| 1% MA | 27.98 | n | 6.0 | 0.42 | 76 | | | 0.24 | −0.0769 |
| 2% VC + 0.2% MA | 26.47 | n | 3.4 | 0.22 | 152 | | | 0.10 | −0.0233 |
| 2% VC + 0.2% OHD | 29.61 | n | 3.8 | 0.24 | 172 | | | 0.07 | −0.0484 |
| 2% VC + 1% OHD | 421.92 | n | 3.8 | 0.30 | 4084 | | | 0.06 | −0.0362 |
| 2% VC + 1% MMDS + 0.5% TTSP + 0.5% | 18.684 | | 3.0 | 0.21 | 85 | 0.088 | 94 | 0.09 | 0.008 |
| TTSPi | | | | | | | | | |
| 2% VC + 1% MMDS + 1% TTSP + 1% | 19.789 | | 3.2 | 0.27 | 80 | 0.067 | 71 | 0.09 | 0.01 |
| TTSPi | | | | | | | | | |
| 2% VC + 2% MMDS + 0.5% TTSP + 0.5% | 22.78 | y | 3.1 | 0.23 | 121 | 0.067 | 94 | 0.10 | 0.0112 |
| TTSPi | | | | | | | | | |
| 2% VC + 2% MMDS + 1% TTSP + 1% | | y | | | | 0.096 | 107 | 0.11 | |
| TTSPi | | | | | | | | | |
| 2% VC + 2% MMDS + 2% TTSP + 1% | 19.9310 | | 3.9 | 0.31 | 59 | | | 0.20 | 0.0926 |
| TTSPi | | | | | | | | | |
| 2% VC + 1% TMS + 0.5% TTSP + 0.5% | 17.683 | | 3.3 | 0.22 | 67 | | | 0.09 | 0.0713 |
| TTSPi | | | | | | | | | |
| 2% VC + 1% TMS + 1% TTSP + 1% TTSPi | 19.578 | | 3.8 | 0.29 | 62 | | | 0.16 | 0.0584 |
| 2% VC + 2% TMS + 0.5% TTSP + 0.5% | 21.28 | y | 3.5 | 0.28 | 87 | | | 0.05 | 0.0791 |
| TTSPi | | | | | | | | | |
| 2% VC + 2% TMS + 1% TTSP + 1% TTSPi | 19.166 | | 3.6 | 0.25 | 70 | | | 0.10 | 0.0812 |
| 2% VC + 2% TMS + 2% TTSP + 1% TTSPi | 19.537 | | 3.9 | 0.27 | 63 | | | 0.08 | 0.0874 |
| 2% VC + 1% DTD + 0.5% TTSP + 0.5% | 21.49 | y | 3.3 | 0.26 | 97 | | | 0.30 | 0.3022 |
| TTSPi | | | | | | | | | |
| 2% VC + 1% DTD + 1% TTSP + 1% TTSPi | 19.035 | | 3.5 | 0.27 | 66 | | | 0.43 | 0.4261 |
| 2% VC + 2% DTD + 0.5% TTSP + 0.5% | 26.77 | y | 3.9 | 0.27 | 135 | | | 0.32 | 0.3247 |
| TTSPi | | | | | | | | | |
| 2% VC + 2% DTD + 1% TTSP + 1% TTSPi | 25.22 | y | 3.5 | 0.22 | 139 | | | 0.36 | 0.361 |
| 2% VC + 2% DTD + 2% TTSP + 1% TTSPi | 23.65 | y | 3.9 | 0.25 | 108 | | | 0.44 | 0.4382 |
| 2% VC + 1% ES + 1% TTSPi | 16.562 | | 3.6 | 0.26 | 42 | 0.068 | 39 | 0.06 | 0.0332 |
| 2% VC + 2% ES + 2% TTSPi | 15.941 | | 3.6 | 0.25 | 36 | 0.095 | 42 | 0.18 | 0.0266 |
| 2% VC + 1% PS + 1% TTSPi | 23.57 | y | 3.1 | 0.20 | 135 | 0.067 | 136 | 0.08 | 0.0018 |
| 2% VC + 2% PS + 2% TTSPi | 33.06 | y | 2.9 | 0.17 | 238 | 0.065 | 193 | 0.15 | 0.0035 |
| 2% VC + 1% PES + 1% TTSPi | 22.83 | y | 3.3 | 0.22 | 119 | 0.056 | 125 | 0.05 | 0.0003 |
| 2% VC + 2% PES + 2% TTSPi | 33.22 | y | 3.3 | 0.15 | 237 | 0.054 | 197 | 0.05 | 0.0007 |
| 1% PES | 21.39 | n | 4.5 | 0.35 | 54 | 0.103 | 66 | 0.08 | 0.0066 |
| 2% PES | 22.15 | n | 3.5 | 0.26 | 99 | 0.082 | 133 | 0.17 | 0.0068 |
| 2% VC + 1% PES | 29.75 | n | 2.8 | 0.21 | 198 | 0.081 | 279 | 0.10 | 0.0186 |
| 2% VC + 2% PES | 44.37 | n | 3.1 | 0.28 | 326 | 0.079 | 442 | 0.19 | 0.012 |
| 2% VC + 1% ES + 1% MMDS + 1% TTSPi | | y | | | | 0.067 | 109 | | |
| 2% VC + 1% ES + 1% TMS + 1% TTSPi | | y | | | | 0.068 | 164 | | |
| 2% VC + 1% ES + 1% DTD + 1% TTSPi | | y | | | | 0.079 | 59 | | |
| 2% VC + 1% ES + 1% PES + 1% TTSPi | | y | | | | 0.081 | 90 | | |
| 2% VC + 1% ES + 1% MMDS | | y | | | | 0.109 | 92 | | |
| 2% VC + 2% ES + 2% MMDS | | y | | | | 0.097 | 145 | | |
| 2% VC + 1% ES + 1% TMS | | m | | | | 0.100 | 89 | | |
| 2% VC + 2% ES + 2% TMS | | m | | | | 0.090 | 89 | | |
| 2% VC + 1% ES + 1% DTD | | m | | | | 0.084 | 121 | | |
| 2% VC + 2% ES + 2% DTD | | m | | | | 0.102 | 179 | | |
| 2% VC + 1% ES + 1% PES | | m | | | | 0.080 | 160 | | |
| 2% VC + 2% ES + 2% PES | | m | | | | 0.091 | 243 | | |
| 3% BMI | | n | | | | 0.113 | 70 | 0.43 | |
| 2% VC + 3% BMI | | n | | | | 0.051 | 258 | 0.07 | |
| 2% VC + 3% BMI + 1% MMDS | | n | | | | 0.063 | 1720 | 0.06 | |

TABLE 2
List of properties of NMC111/graphite cells with electrolyte additives listed in first
column

| | | | | | | | | | | Gas | Rct |
|---|---|---|---|---|---|---|---|---|---|---|---|
| | | | CE | | Ch. | V | Rct | Gas | Gas | stor. | after |
| | | | (last 3 | CIE/h * | slippage | drop | after | Form. | Cyc. | 60 C. | 60 C. |
| Additive | inv | fom | cycle) | 10\hat{ }5 | mAh/cy | 60° C. | cyc. | (mL). | (mL) | (mL) | stor. |
| 2% PES | P | 26.7 | 0.998402 | 3.95 | 0.242 | 0.133 | 94.6 | 0.076 | 0.005 | 0.1 | 69.2 |
| 2% PES + 1% MMDS | PM | 29.2 | 0.998663 | 3.34 | 0.209 | 0.127 | 144 | 0.172 | 0.005 | 0.099 | 88.8 |
| 2% PES + 1% DTD | PD | 29.4 | 0.998638 | 3.37 | 0.192 | 0.123 | 152.7 | 0.103 | 0.001 | 0.113 | 90.2 |
| 2% PES + 1% ES | PE | 29.1 | 0.998136 | 4.66 | 0.324 | 0.145 | 72.2 | 0.188 | 0.021 | 0.08 | 59.2 |
| 2% PES + 1% TTSPi | PT | | | | | 0.11 | | 0.055 | | 0.085 | 66.5 |
| 2% | PMT | 27.1 | 0.998872 | 2.78 | 0.158 | 0.119 | 154.9 | 0.079 | −0.009 | 0.057 | 111.3 |
| PES + 1% MMDS + 1% TTSPi | | | | | | | | | | | |
| 2% | PDT | 36.1 | 0.998896 | 2.71 | 0.142 | 0.112 | 251.8 | 0.067 | −0.005 | 0.232 | 211.8 |
| PES + 1% DTD + 1% TTSPi | | | | | | | | | | | |
| 2% PES + 1% ES + 1% TTSPi | PET | 26.5 | 0.998544 | 4.17 | 0.33 | 0.13 | 53.9 | 0.136 | 0.005 | 0.081 | 55.8 |
| 2% | P(TM)T | 23.4 | 0.998631 | 3.42 | 0.194 | 0.104 | 91.2 | 0.026 | 0 | 0.091 | 86.8 |
| PES + 1% TMS + 1% TTSPi | | | | | | | | | | | |
| 2% VC | VC | 24.3 | 0.998298 | 4.25 | 0.219 | 0.105 | 74 | 0.133 | 0.011 | 0.686 | 73.2 |

### Examples of Typical Data

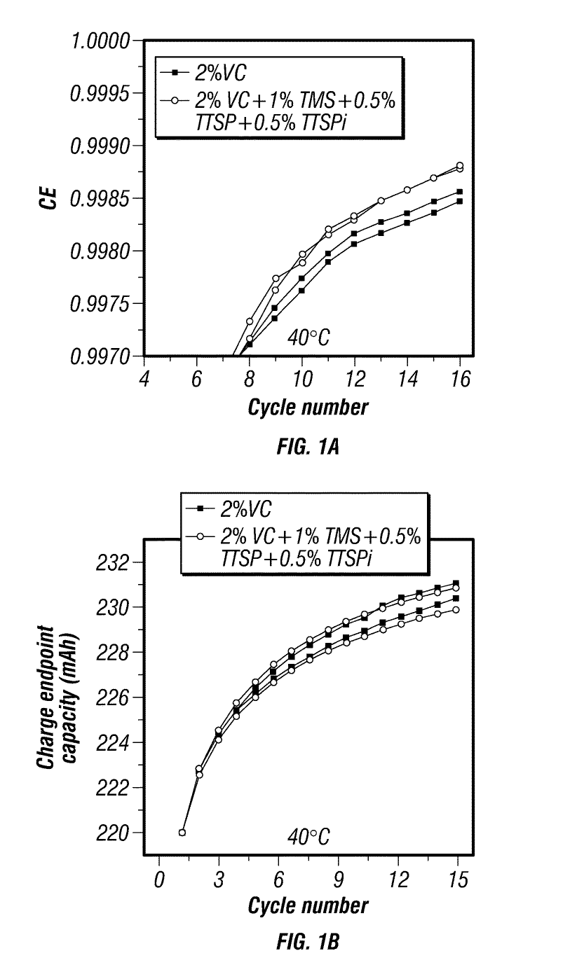

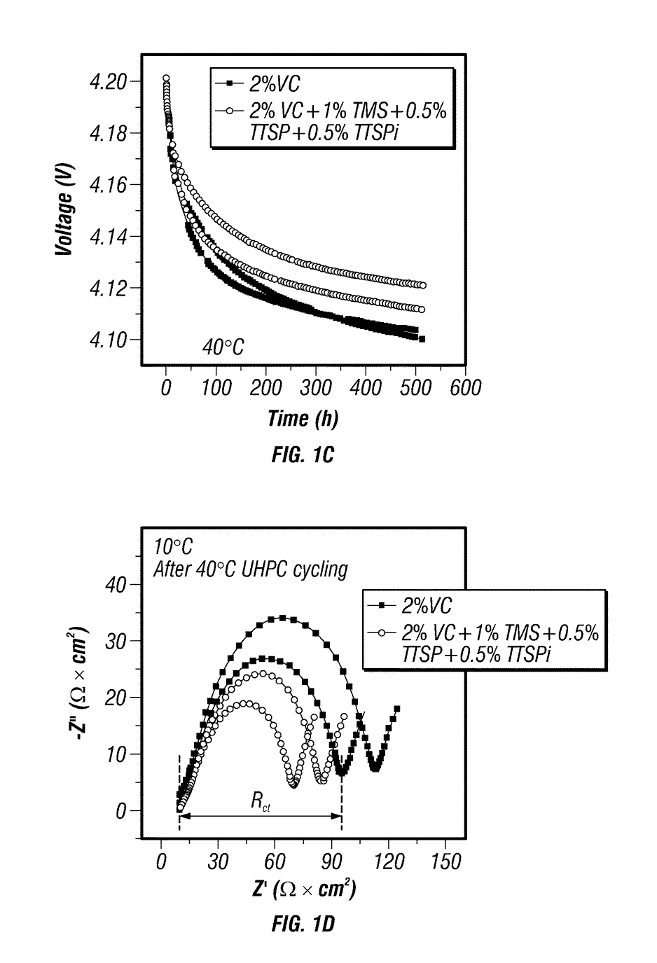

FIG. 1 shows typical data collected during some of these experiments. Two electrolyte additive systems were selected for comparison, 2% VC and 2% VC+1% TMS+0.5 TTSP+0.5% TTSPi. FIG. 1a shows coulombic efficiency (CE) versus cycle number. FIG. 1 shows that cells with 2% VC+1% TMS+0.5 TTSP+0.5% TTSPi have a higher CE than cells with 2% VC and would have a longer lifetime. Table 1 includes a column for “coulombic inefficiency per hour” which is calculated as follows:

CIE/h=[1−(avg. CE cycles 13 to 15)]/40 equation 2

where the “40” in equation 2 is the time of one cycle in hours.

FIG. 1b shows the capacity of the charge endpoint plotted versus cycle number. Table 1 includes a column for “charge endpoint capacity slippage (charge slippage)” which is calculated as the slope of the data in FIG. 1b for cycles 11 to 15 (units are mAh/cycle). Cells with smaller charge endpoint capacity slippage rates show less electrolyte oxidation at the positive electrode and generally show longer lifetimes.

FIG. 1c shows open circuit voltage versus time during storage at 4.2 V and 40° C. The difference between 4.2 V and the voltage after 500 hours of storage is called the “voltage drop” or V_{drop}. Cells with smaller values of V_{drop} usually show longer lifetime. Table 1 lists a column for V_{drop} for cells stored at 40° C. The experiments described in Table 2 had the storage experiments performed at 60° C.

FIG. 1d shows AC impedance spectra for cells measured after the 15 cycles of UHPC testing. The measurements are made at 3.8 V with the cells at 10° C. The diameter of the semicircle represents the sum of the charge-transfer resistances, R_{ct}, at both the positive and negative electrodes and is indicated in FIG. 1d. Both Tables 1 and 2 include values of R_{ct} measured after UHPC cycling and also after storage.

By most of the metrics of FIG. 1, electrolyte with 2% VC+1% TMS+0.5 TTSP+0.5% TTSPi additive is better than an electrolyte with only 2% VC.

### Figure of Merit

In order to compare the additives listed in Tables 1 and Table 2, a “Figure of Merit” was established. It is important that cells simultaneously have high coulombic efficiency (low CIE/h), small charge endpoint capacity slippage and small charge transfer resistance to be suitable for applications that require long lifetime and high rate capability. The Figure of Merit (FOM) was taken to be:

FOM=(CIE/h)×2×10⁵+20×(Charge Slippage)+0.1×R_{ct}

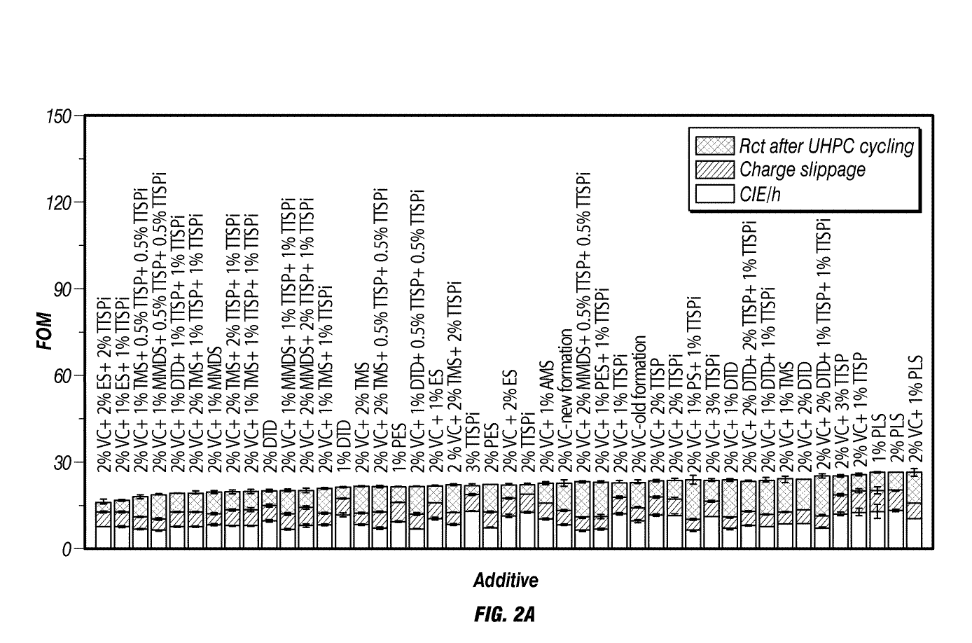

for the results in Table 1 which are plotted in FIG. 2.

The FOM was taken to be:

FOM=(CIE/h)×2×10⁵+38.6×(Charge Slippage)+0.1×R_{ct}

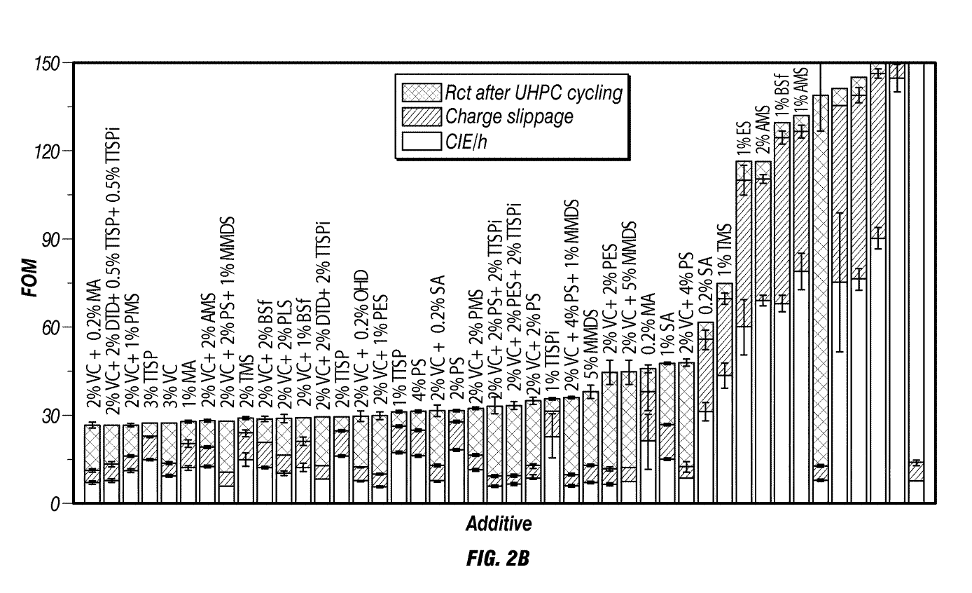

for the results in Table 2 which are plotted in FIG. 3.

These expressions weight the contributions of coulombic efficiency, charge endpoint capacity slippage and impedance roughly equally for the cases of the two types of cells considered. The FOM values in FIGS. 2a-b and 3 can only be compared within those figures not between those figures. The three components that make up the Figure of Merit are designated with different shadings in FIGS. 2a-b and 3. Electrolytes with the smallest FOM are the often the best all-around performers.

Reference [4] shows the importance of simultaneously maximizing coulombic efficiency and minimizing R_{ct} in cells destined for high rate applications. For cells destined for low rate applications or high temperature applications, low values of R_{ct} may be less important than high values of CE and low values of voltage drop during storage. The inventive electrolyte compositions allow one to adjust composition achieve desired performance under a variety of conditions.

Reference [5] shows a variety of similar measurements carried out with a large number of different electrolyte additives compared to the inventive ones described here. In reference [5], it was very difficult to find additive mixtures that could beat the all-around performance of 2% VC. The inventive compositions described here are much better than 2% VC.

### Consideration of the Results for Table 1

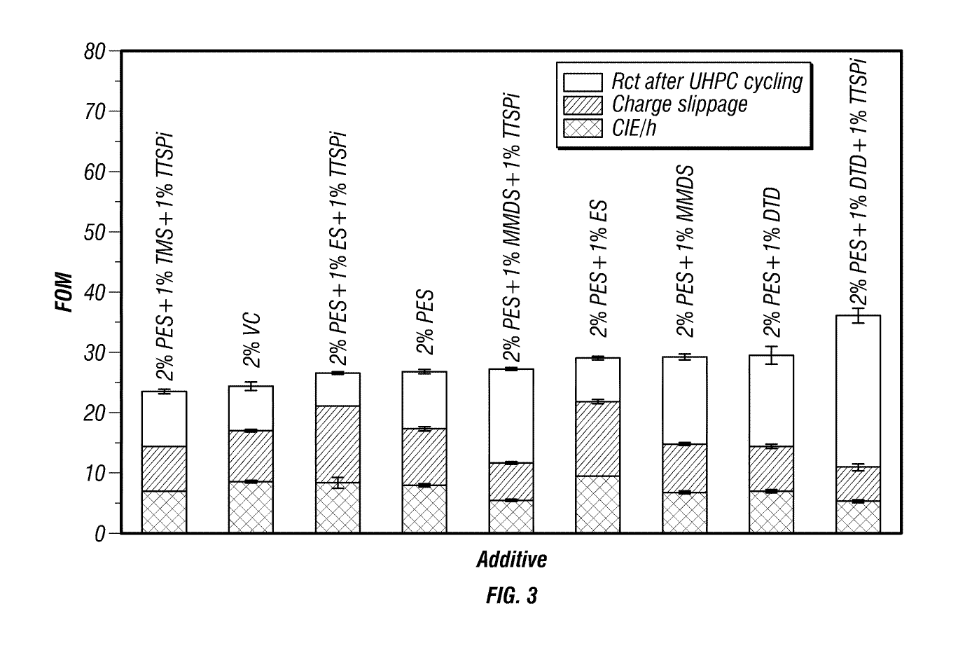

FIG. 2 shows the Figure of Merit for the electrolyte additives considered in Table 1. The 7 electrolytes with the smallest FOM are electrolytes that contain VC+sulfur-containing+TTSP/TTSPi. Of the 12 electrolytes that have the lowest FOM, 10 are VC+sulfur-containing+TTSP/TTSPi, one is 2% VC+1% MMDS and the other is 2% DTD. This suggests that electrolytes with the additive combination “VC+sulfur-containing+TTSP/TTSPi” impart beneficial properties to Li-ion cells. Thus these are labeled as “inventive”. The third column in Table 1 labels the various electrolyte additives as “y” (i.e. belong to the inventive class), “n” (i.e. do not belong to the inventive class) and by other designations (electrolytes with the other designations do not belong to the inventive class but are marked differently for reference). Column 3 lists 10 inventive additive combinations as 1, 2 . . . 10. These are the 10 “best” inventive additives based on the FOM in Table 1. Column 3 also lists 2% VC+1% MMDS as “A” and 2% DTD as “B”. The two entries in Table 1 that involve only VC are marked as VC in column 3 of Table 1. The reason for these designations is so that FIGS. 4-10 can be more easily interpreted.

FIG. 4 shows a plot of R_{ct} measured after UHPC cycling versus CIE/h for all additives in Table 1 where data is available. Notice that inventive compositions 1-10 all lie nearest to the origin of this graph. This means they would yield cells with the lowest impedance and largest coulombic efficiency, probably leading to cells with the longest lifetime under high-rate compositions. These compositions show significant advantages over VC as well as compositions A and B. The other inventive compositions, marked with “y” in FIG. 4 generally lie much closer to the origin than the non-inventive compositions (marked with “n”). When TTSP and TTSPi are added to composition “A”, to yield inventive composition “4”, the CIE/h improves significantly while the impedance is hardly affected. FIG. 4 clearly shows the advantages of the inventive compositions.

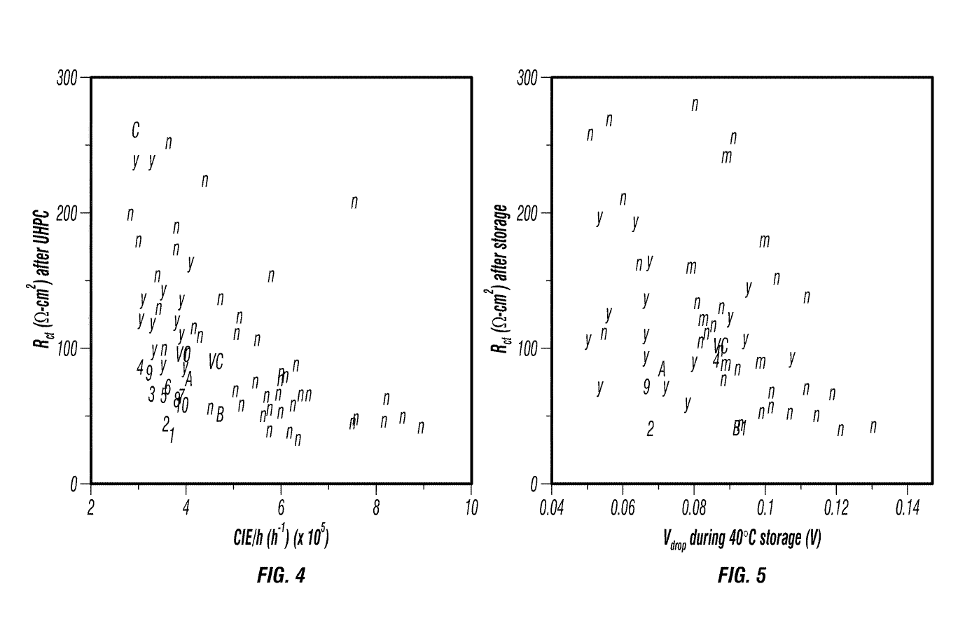

FIG. 5 shows a plot of R_{ct} after storage versus the voltage drop during storage. Data for all inventive compositions 1-10 is not available. However, FIG. 5 shows that all but one of the 10 compositions closest to the origin of FIG. 5 are inventive compositions. Being close to the origin means that compositions which limit electrolyte oxidation at the positive electrode do not simultaneously lead to high impedance.

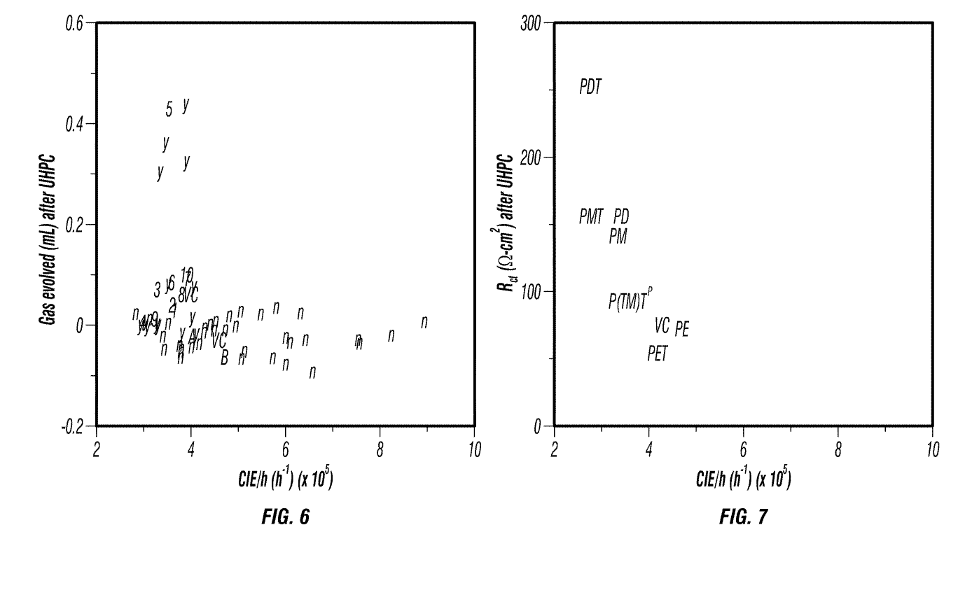

FIG. 6 shows a graph of gas evolved after UHPC cycling plotted versus coulombic inefficiency. FIG. 6 shows that inventive compositions 1-10 (except for #5) do not generate large amounts of gas. Inventive composition 5 contains DTD which is responsible for the large amount of gas. In fact the cluster of “y” symbols around point #5 all contain DTD. These electrolytes show low CIE/h (good) but not insignificant amounts of gas in pouch cells. They may be more suitable for cylindrical cells where bulging of cell cans is not an issue.

### Advantageous Properties of Inventive Compositions Cannot be Predicted

The properties of the inventive compositions cannot be predicted based on the properties of VC and of the binary additive mixtures. For instance, consider the following example. The average values of CIE/h, Charge slippage and R_{ct} for the two 2% VC data in table 1 are 4.3, 0.24 and 93, respectively. The changes in CIE/h, Charge slippage and R_{ct} for 2% VC+1% MMDS compared to 2% VC are −0.2, −0.05 and −17.1, as can be calculated from Table 1. The changes in CIE/h, Charge slippage and R_{ct} for 2% VC+1% TTSP compared to 2% VC are 2.0, 0.11 and 35.7, as can be calculated from Table 1. The changes in CIE/h, Charge slippage and R_{ct} for 2% VC+1% TTSPi compared to 2% VC are 1.7, 0.05 and −40.0, as can be calculated from Table 1. Therefore, one predicts values for 2% VC+1% MMDS+1% TTSP+1% TTSPi for the CIE/h, Charge slippage and R_{ct} of 7.7, 0.35 and −0.9, respectively, compared to measured values of 3.2, 0.27 and 80. This example shows that the values measured for the binary mixtures cannot be used to accurately predict those of the ternary and quaternary inventive examples. Thus the mixed electrolyte additives do show unexpected properties.

### Consideration of the Results for Table 2

Table 2 considers electrolytes that contain PES, instead of VC, as the primary electrolyte additive. FIG. 3 shows the FOM for these electrolyte systems in Table 2. Many of these additive systems have FOM comparable to 2% VC.

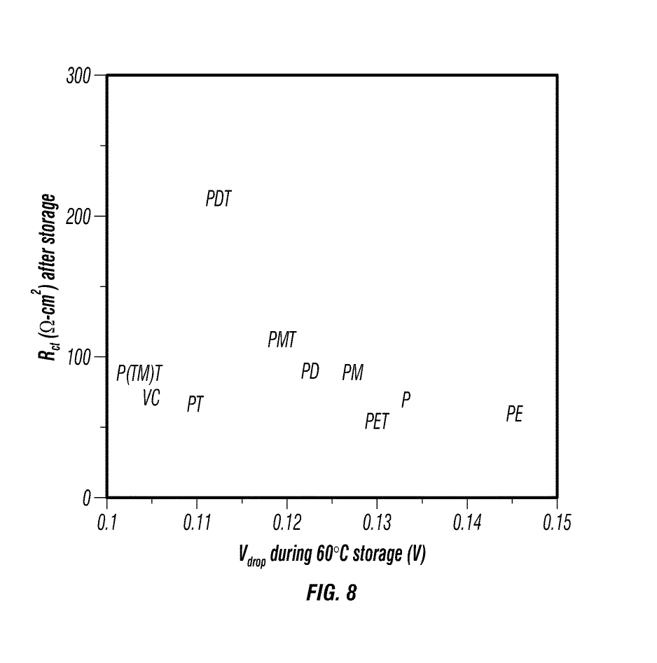

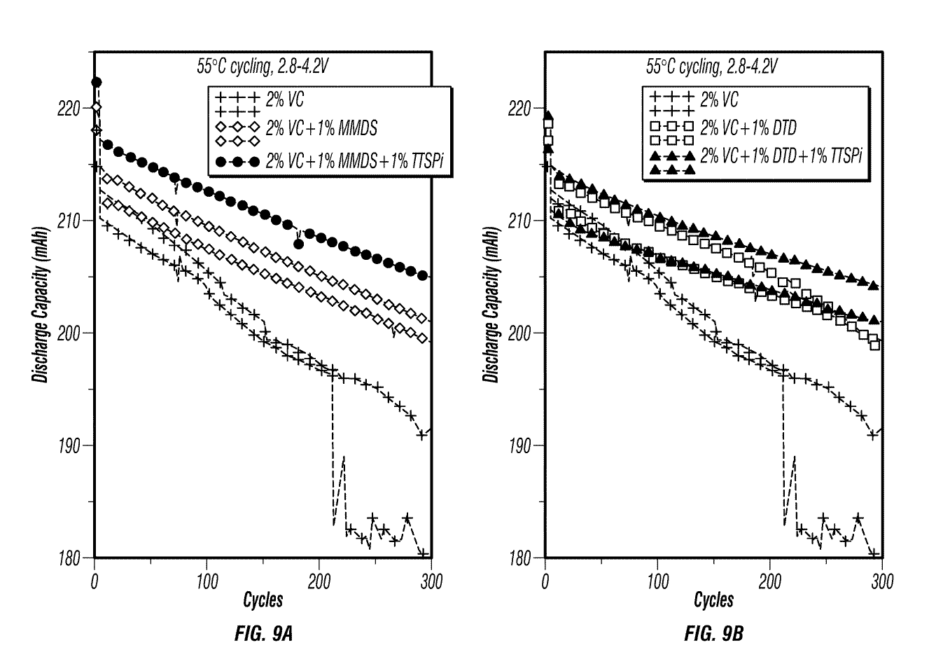

The interest in these additive systems (Table 2) comes from the fact that electrolytes with 2% VC generate substantial amounts of gas during storage at 60° C. (see Table 2, bottom row) while all other electrolytes in Table 2 that contain PES do not generate significant amounts of gas during 500 hours of storage at 60° C. Column 2 in Table 2 gives the “code” for the electrolyte additives used in FIGS. 7 and 8. FIG. 7 shows R_{ct} versus CIE/h for the electrolytes in Table 2. Electrolytes with PES+TMS+TTSPi and PES+ES+TTSPi are very attractive suggesting that PES can be substituted for VC in some inventive electrolyte systems with the added advantage of virtually no gassing at high temperature storage.

It is especially interesting to compare how R_{ct} after UHPC is reduced from 2% PES to 2% PES+1% ES to 2% PES+1% ES+1% TTSPi. This similar feature of impedance reduction is also observed if VC replaces PES.

Also of interest in Table 2 and FIGS. 7 and 8 are the mixtures 2% PES+1% MMDS+1% TTSPi and 2% PES+1% DTD+1% TTSPi. These blends have the smallest sums of CIE/h and charge slippage of all the blends that contain PES. This can also be gleaned from FIG. 3. These blends would be expected to have the best long-term cycle life at elevated temperature where the impact of parasitic reactions far outweighs that of impedance.

### Long Term Cycling Results for Some Inventive Compositions

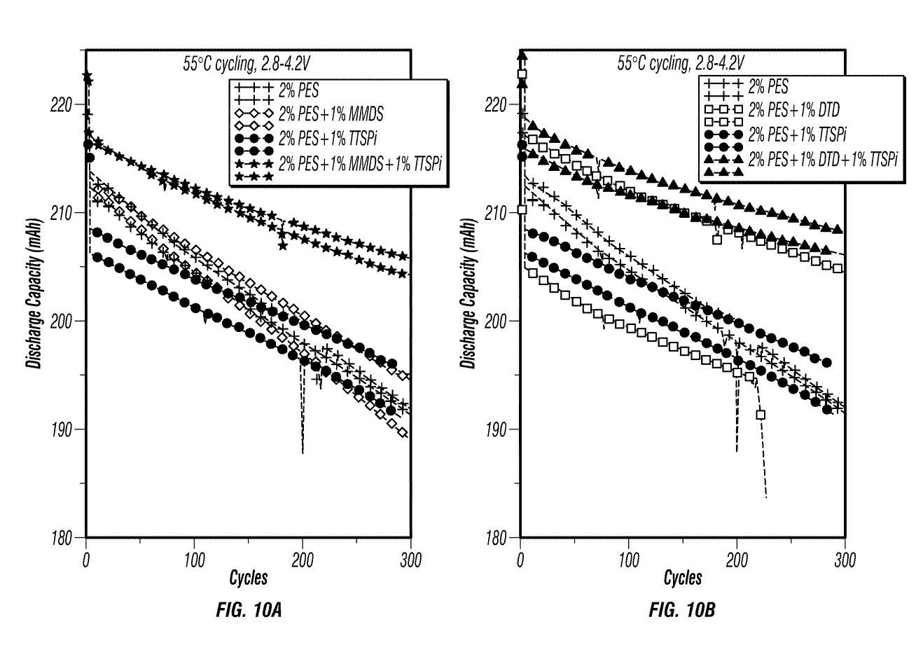

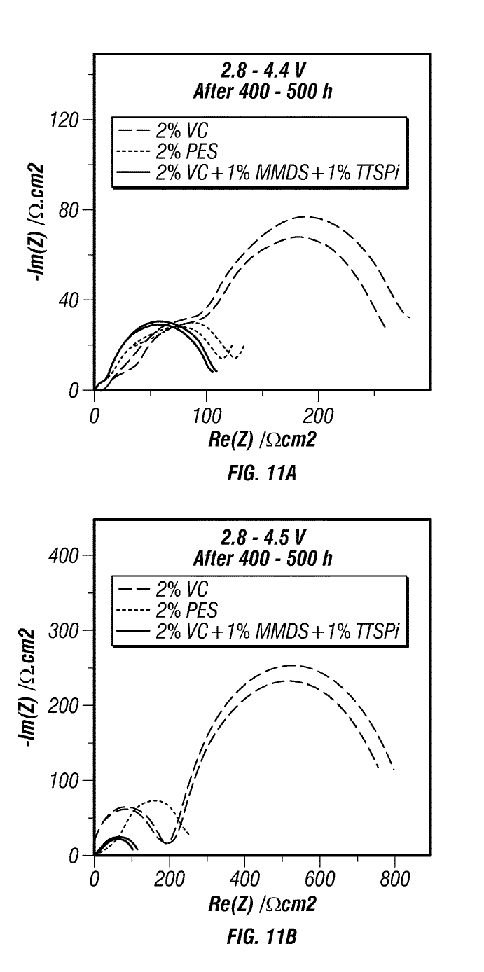

Pouch cells of the 4.4 V variety were charged and discharged at 80 mA (C/2.5) between 3.0 and 4.2 V at 55° C. These pouch cells contained comparative and inventive electrolyte mixtures. FIG. 9a shows results for 2% VC, 2% VC+1% MMDS and the inventive composition 2% VC+1% MMDS+1% TTSPi. FIG. 9b shows results for 2% VC, 2% VC+1% DTD and the inventive composition 2% VC+1% DTD+1% TTSPi. FIGS. 9a and 9b show that inventive compositions yield better charge discharge cycle life as can be expected based on the CIE/h and charge slippage results in Table 1. FIG. 10a shows results for 2% PES, 2% PES+1% MMDS, 2% PES+1% TTSPi and the inventive composition 2% PES+1% MMDS+1% TTSPi. FIG. 10b shows results for 2% PES, 2% PES+1% DTD, 2% PES+1% TTSPi and the inventive composition 2% PES+1% DTD+1% TTSPi. FIGS. 10a and b show that the inventive compositions yield better charge discharge cycle life as can be expected based on the CIE/h and charge slippage results in Table 2. Gas volumes measured after 200 cycles shows that all PES-containing cells evolved less than 0.08 mL of gas while the VC-containing cells evolved up to 0.25 mL of gas. This again points to the advantages of PES blends for suppressing gas evolution at high temperature.

### Impact of Inventive Electrolytes on High Potential Cycling

FIGS. 11a-d show the AC impedance spectra of NMC442/graphite cells cycled between the indicated potential limits for 400 to 500 hours at 40° C. Notice how the impedance for VC-containing cells is much larger than those for PES-containing cells and both are much larger than that of 2% VC+1% MMDS+1% TTSPi at 4.5 V and higher. This suggests the inventive compositions have value for stabilizing impedance growth during high potential cycling.

FIG. 12a shows isothermal microcalorimetry results (using the methods of reference [6]) for NMC111/graphite pouch cells (4.4V balanced cells) containing various electrolyte additives. The data collected during the charge of the cells is shown in the solid lines while that collected during the discharge of the cells is shown as the dashed lines. The control A electrolyte is 1M LiPF6 EC:EMC (3:7). Cells with control A electrolyte show the most parasitic heat. When 2% VC is added, the parasitic heat is reduced as shown in FIG. 12a. The control B electrolyte is Control A+1% TTSPi. Thus the three data sets involving control B are all inventive electrolytes. The inventive electrolytes all lower the parasitic heat compared to Control A+2% VC dramatically, especially above 4.2V. This suggests that the inventive electrolytes will show improved cycling behaviour in 4.4V cycling compared to 2% VC, in agreement with the results in FIGS. 11a-d. FIG. 12b shows the difference between the heat flow from control A and the various other electrolytes. The open symbols in FIG. 12b are for the charge and the solid symbols are for the discharge. The inventive electrolytes reduce the parasitic heat dramatically compared to 2% VC above 4.2 V.

### Long Term Cycling at 55° C.

Dry Li[Ni_{1/3}Mn_{1/3}Co_{1/3}]O₂ (NMC111)/graphite pouch cells (220 mAh) balanced for 4.2V operation were obtained from Whenergy (Shandong, China). All pouch cells were vacuum sealed without electrolyte in China and then shipped to our laboratory in Canada. Before electrolyte filling, the cells were cut just below the heat seal and dried at 80° C. under vacuum for 12 h to remove any residual water. Then the cells were transferred immediately to an argon-filled glove box for filling and vacuum sealing. The NMC/graphite pouch cells were filled with 0.9 g of electrolyte. After filling, cells were vacuum-sealed with a compact vacuum sealer (MSK-115A, MTI Corp.). First, cells were placed in a temperature box at 40.0±0.1° C. where they were held at 1.5 V for 24 hours, to allow for the completion of wetting. Then, cells were charged at 11 mA (C/20) to 4.2 V and discharged to 3.8 V. After this step, cells were transferred and moved into the glove box, cut open to release gas generated and then vacuum sealed again. Control electrolyte (Comparative example) was 1M LiPF6 EC:EMC 3:7 obtained from BASF. Sample electrolytes (Examples) contain the control electrolyte with addition of electrolyte additives in Table 3, 4 and 5. Cells were then moved to a Neware battery tester and charged and discharged at 80 mA between 2.8 and 4.2 V at 55° C. Test results for cells containing electrolytes with VC plus other additives are listed in Table 3. Test results for cells containing PES plus other additives are listed in Table 4.

TABLE 3

| Additives | Last cycle number | Capacity loss (%) |
|---|---|---|
| Control Electrolyte | 227 | 27.4 |
| 2 wt % VC | 1000 | 23.7 |
| 2 wt % VC + 1 wt % DTD | 1000 | 23.9 |
| 2 wt % VC + 1 wt % MMDS | 1000 | 26.3 |
| 2 wt % VC + 1% MMSD + 1 wt | 1000 | 23.2 |
| % TTSPi | | |
| 2 wt % VC + 1% DTD + 1 wt | 1000 | 22.3 |
| % TTSPi | | |

TABLE 4

| Additives | Last cycle number | Capacity loss (%) |
|---|---|---|
| Control | 227 | 27.4 |
| 2 wt % PES | 718 | 26.4 |
| 2 wt % PES + 1 wt % DTD | 1000 | 18.6 |
| 2 wt % PES + 1 wt % MMDS | 656 | 24.9 |
| 2 wt % PES 1 wt % TTSPi | 629 | 23.4 |
| 2 wt % PES + 1% MMDS + | 1000 | 15.0 |
| 1 wt % TTSPi | | |
| 2 wt % PES + 1% DTD + 1 wt | 1000 | 11.9 |
| % TTSPi | | |

Tables 3 and 4 show the advantages of the inventive compositions, especially 2% PES+1% MMDS+1% TTSPi and 2% PES+1% DTD+1% TTSPi.

### Automated Impedance Spectroscopy/Charge-Discharge Cycling Experiments

Dry (no electrolyte) Li[Ni_{0.42}Mn_{0.42}Co_{0.16}]O₂ (NMC442)/graphite pouch cells (240 mAh) balanced for 4.7 V operation were obtained from Lifun Technologies and used for automated impedance spectroscopy/cycling experiments. The pouch cells were 40 mm long×20 mm wide×3.5 mm thick. The electrode composition in the cells was as follows: Positive electrode—96.2%:1.8%:2.0%=Active Material:Carbon Black:PVDF Binder; Negative electrode 95.4%:1.3%:1.1%:2.2%=Active material:Carbon Black:CMC:SBR. The positive electrode coating had a total thickness of 105 μm, a single side coating thickness of 47.5 μm and was calendared to a density of 3.55 g/cm³. The negative electrode coating had a total thickness of 110 μm, a single side coating thickness of 51 μm and was calendared to a density of 1.55 g/cm³. The positive electrode coating had an areal density of 16 mg/cm² and the negative electrode had an areal density of 9.5 mg/cm². The positive electrode dimensions were 200 mm×26 mm and the negative electrode dimensions were 204 mm×28 mm. Both electrodes were coated on both sides, except for small regions on one side at the end of the foils leading to an active area of approximately 100 cm². The electrodes are spirally wound, not stacked, in these pouch cells.

Before electrolyte filling, the cells were cut just below the heat seal and dried at 80° C. under vacuum for 12 h to remove any residual water. Then the cells were transferred immediately to an argon-filled glove box for filling and vacuum sealing. The NMC/graphite pouch cells were filled with 0.9 g of electrolyte. After filling, cells were vacuum-sealed with a compact vacuum sealer (MSK-115A, MTI Corp.). First, cells were placed in a temperature box at 40.0±0.1° C. where they were held at 1.5 V for 24 hours, to allow for the completion of wetting. Then, cells were charged at 11 mA (C/20) to 4.4 V. After this step, cells were transferred and moved into the glove box, cut open to release gas generated and then vacuum sealed again.

The cells were placed on a custom build charge-discharge station which could be programmed to measure the impedance spectra of the cells as desired. The cells underwent the following protocol involving steps A) and B) defined as follows: Step A) Charge to 4.4 V at C/5, hold at 4.4V for 20 h, then discharge to 2.8V at C/5; Step B) Charge at C/20 to 4.4 V while measuring EIS spectra every 0.1 V and then discharge at C/20 to 2.8 V while measuring EIS spectra every 0.1 V. The cells were tested at 40° C. and underwent repeated sequences of 3 step A) protocols and 1 step B) protocol. That is, the tests ran as the following steps in sequence: A A A B A A A B A A A B . . . .

Table 5 shows the results of the cycle-hold-cycle testing described in the paragraph above. The AC impedance spectra were collected with ten points per decade from 100 kHz to 10 mHz with a signal amplitude of 10 mV at 40.0±0.1° C. The AC impedance spectra were plotted as a Nyquist diagram and the diameter of the semicircle in the Nyquist plot represents the sum of the charge-transfer resistances, R_{ct}, at both the positive and negative electrodes and is indicated for the last charge-discharge cycle of the cells in Table 3, measured at 4.4 V. All cells begin testing with R_{ct} near 0.2Ω at 4.4 V. The value of R_{ct} rises steadily with cycle count, so a value of 1.0Ω after only 27 cycles for control electrolyte represents a significantly worse situation than a value of 0.9Ω for one of the inventive electrolytes after 95 cycles. Table 5 shows that the inventive electrolyte compositions yield cells with longer cycle life and significantly lower impedance when cycled aggressively to 4.4 V at 40° C.

TABLE 5
Results from Automated Impedance Spectroscopy/Charge-Discharge
Cycling experiments

| | | Number of | R_{ct} at 4.4 V |
|---|---|---|---|
| | Initial | cycles to | at the |
| | capacity | 200 mAh | last cycle |
| Additive | (mAh) | (83% capacity) | (Ω) |
| Control | 240 | 27 | 1.0 |
| 2% VC | 240 | 57 | 1.6 |
| 2% DTD + 2% TTSPi | 240 | 72 | 2.3 |
| 2% PES + 2% DTD + | 240 | >100 (test | 0.3 |
| 2% TTSPi | | stopped at | |
| | | 100 cycles | |
| 2% PES + 1% DTD + | 240 | 95 | 0.9 |
| 2% TTSPi | | | |
| 2% PES + 2% DTD + | 240 | 100 | 0.4 |
| 1% TTSPi | | | |

The preceding examples show that use of the electrolytes of the invention can provide one or more of the following benefits:

1) Lower parasitic heat during isothermal battery microcalorimetry measurements indicating a reduction in parasitic reactions between charged electrode materials and electrolyte;
2) Higher coulombic efficiency and lower charge endpoint capacity slippage rates indicating a reduction in parasitic reaction rates;
3) Lower charge transfer impedance after cycling suggesting the formation of more ideal passivation films on the electrode surfaces;
4) Amounts of gas generation during extended cycling that are less than or equivalent to those produced by cells with VC only (except for cells with DTD).
5) Better capacity retention during long-term cycling at 55° C.

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since further modifications may be made by those skilled in the art without departing from the spirit and scope of the present disclosure, particularly in light of the foregoing teachings. Such modifications are to be considered within the purview and scope of the claims appended hereto.

1. A nonaqueous electrolyte for a lithium ion battery comprising a lithium salt, a nonaqueous carbonate solvent, and an additive mixture comprising at least one group A compound, at least one group B compound, and at least one group C compound wherein the group A compound is selected from the group consisting of VC and PES, the group B compound is selected from the group consisting of MMDS, DTD, TMS, ES, PS, and the group C compound is selected from the group consisting of TTSP and TTSPi.

2. The nonaqueous electrolyte of claim 1 wherein the concentration of the at least one group A compound is in the range from 0.5 to 3% by weight.

3. The nonaqueous electrolyte of claim 1 wherein the concentration of the at least one group B compound is in the range from 0.25 to 3% by weight.

4. The nonaqueous electrolyte of claim 1 wherein the concentration of the at least one group C compound is in the range from 0.25 to 3% by weight.
